(19) United States
(12) Patent Application Publication
(10) Pub. No.: US 2026/0163350 A1
(43) Pub. Date: Jun. 11, 2026

(54) WIRE HARNESS HOLDING STRUCTURE

(71) Applicant: TOYOTA JIDOSHA KABUSHIKI KAISHA, Toyota-shi (JP)

(72) Inventor: Tomohiro KAJIWARA, Toyota-shi (JP)

(73) Assignee: TOYOTA JIDOSHA KABUSHIKI KAISHA, Toyota-shi (JP)

(21) Appl. No.: 19/412,627

(22) Filed: Dec. 8, 2025

(30) Foreign Application Priority Data
Dec. 10, 2024 (JP) 2024-215988

(51) Int. Cl. H02G 3/32; B60R 16/02

(52) U.S. Cl. CPC H02G 3/32; B60R 16/0215

(57) ABSTRACT

A wire harness holding structure holding a wire harness includes a clamp including a U-shaped holding portion holding the wire harness and a main body portion extending from one end of the holding portion and including a bolt hole; and a bolt including a shaft portion and a head portion provided at a tip of the shaft portion. The shaft portion is inserted through the bolt hole from an opening side of the holding portion to fix the clamp to an object to be fixed. The bolt hole and the bolt are configured to shorten a gap length between the other end of the holding portion of the clamp and the head portion of the bolt to less than a diameter of the wire harness.

### CROSS-REFERENCE TO RELATED APPLICATIONS

The present disclosure claims priority to Japanese Patent Application No. 2024-215988 filed Dec. 10, 2024, which is incorporated herein by reference.

### TECHNICAL FIELD

The present disclosure relates to a wire harness holding structure.

### BACKGROUND

A conventional wire harness holding structure of this type has been proposed with a clamp (a bracket) including a U-shaped holding portion holding a wire harness. The holding portion includes a horizontal portion extending horizontally, a spring portion including moderate elasticity, and an arc portion shaped arc and connecting the horizontal portion and the spring portion. The spring portion includes a substantially S-shaped undulating form. An opening width near a U-shaped opening end of the holding portion is shorter than a diameter of the wire harness. This wire harness holding structure suppresses unintended disengagement of the wire harness from the holding portion.

### SUMMARY

In the wire harness holding structure described above, strict tolerances for the holding portion's shape and the opening are necessary to prevent unintended disengagement of the wire harness from the holding portion. Productivity is reduced in the wire harness holding structure described above.

The main purpose of the wire harness holding structure of the present disclosure is to improve productivity.

The wire harness holding structure of the present disclosure has adopted the following means to achieve the main objectives described above.

A wire harness holding structure of this disclosure includes a clamp including a U-shaped holding portion holding the wire harness and a main body portion extending from one end of the holding portion and including a bolt hole; and a bolt including a shaft portion and a head portion provided at a tip of the shaft portion. The shaft portion is inserted through the bolt hole from an opening side of the holding portion to fix the clamp to an object to be fixed. The bolt hole and the bolt are formed such that a gap length between the other end of the holding portion of the clamp and the head portion of the bolt is shorter than a diameter of the wire harness.

In the wire harness holding structure of this disclosure, the bolt hole and the bolt are formed such that a gap length between the other end of the holding portion of the clamp and the head portion of the bolt is shorter than a diameter of the wire harness. This allows the wire harness holding structure to suppress unintended disengagement of the wire harness from the holding portion. In the wire harness holding structure of this disclosure, strict tolerances for the holding portion's shape and the opening are not necessary. This enables to improve productivity.

### BRIEF DESCRIPTION OF DRAWINGS

FIG. 1 is a configuration diagram illustrating the schematic configuration showing a manner of attaching a clamp holding a wire harness using a wire harness holding structure according to one embodiment of the disclosure to an electric vehicle (an object to be fixed).

FIG. 2 is a schematic side view illustrating the configuration of the clamp when the clamp and a bolt in the wire harness retaining structure according to the embodiment are viewed from the side.

FIG. 3 is a configuration diagram illustrating the schematic configuration showing a manner of attaching a clamp holding a wire harness using a wire harness holding structure according to another embodiment of the disclosure to an electric vehicle.

FIG. 4 is a side configuration diagram illustrating the schematic configuration of the clamp as viewed the clamp and a bolt from a side in the wire harness holding structure of another embodiment.

### DESCRIPTION OF EMBODIMENTS

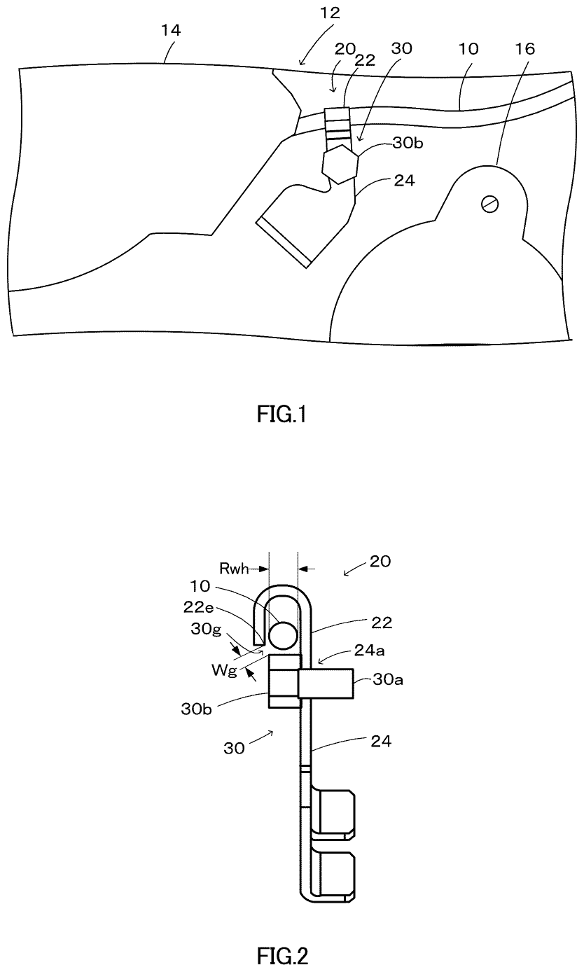

The following is a description of the embodiment of present disclosure with reference to the drawings. FIG. 1 is a configuration diagram illustrating the schematic configuration showing a manner of attaching a clamp holding a wire harness using a wire harness holding structure according to one embodiment of the disclosure to an electric vehicle (an object to be fixed). FIG. 2 is a side configuration diagram illustrating the schematic configuration of the clamp as viewed the clamp and a bolt from a side in the wire harness holding structure of the embodiment. The wire harness holding structure of the embodiment, as shown in FIG. 1, is a structure used to hold a wire harness 10 from a motor 14 positioned within a motor compartment 12 of the electric vehicle using a clamp 20.

As shown in FIG. 1, a clamp 20 is positioned within the motor compartment 12 together with the motor 14 and a resolver 16 detecting rotational speed of the motor 14, and is mounted within the motor compartment 12 by a bolt 30. As shown in FIGS. 1 and 2, the clamp 20 has a holding portion 22 and a main body portion 24. The holding portion 22 is formed in a U-shape and holds a portion of the wire harness 10 within the U-shape. The main body portion 24 extends from one end of the holding portion 22. A bolt hole 24a is formed at the position of the main body portion 24 close to the holding portion 22 side. The bolt 30 has a shaft portion 30a with threads cut on a surface thereof and a hexagonal prism-shaped head portion 30b provided at tip of the shaft portion 30a. The shaft portion 30a of the bolt 30 is inserted through an opening side of the holding portion 22 into the bolt hole 24a and is fixed to an unillustrated bolt hole provided in the motor compartment 12. In the wire harness holding structure of this embodiment, the clamp 20 is fixed within the motor compartment 12 by the bolt 30.

In the wire harness holding structure of the embodiment having the configuration described above, as shown in FIG. 2, the bolt hole 24a of the main body portion 24 of the clamp 20 and the bolt 30 are formed such that a length Wg of a gap 30g between the other end 22e of the holding portion 22 of the clamp 20 and the head portion 30b of the bolt 30 is shorter than a diameter Rwh of the wire harness 10.

By using the bolt hole 24a and the bolt 30 described above, when the clamp 20 holds the wire harness 10, the wire harness 10 is positioned within the U-shaped portion of the holding portion 22 and then inserting the bolt 30 through the bolt hole 24a of the clamp 20. This enables to shorten the length Wg to less than the diameter Rwh and to prevent the wire harness 10 from disengaging from the holding portion 22. In the wire harness holding structure of the embodiment, strict tolerances for a shape of the holding portion 22 and the gap 30g are not necessary, and additional components to prevent the wire harness 10 from detaching from the holding portion 22 are not necessary. This enables to improve in assembly ease. In the wire harness holding structure of this embodiment, this enables to improve productivity.

In the wire harness holding structure of the embodiment described above, the bolt hole 24a of the main body portion 24 of the clamp 20 and the bolt 30 are formed such that the length Wg of the gap 30g between the other end 22e of the holding portion 22 of the clamp 20 and the head portion 30b of the bolt 30 is shorter than the diameter Rwh of the wire harness 10. This enables to improve productivity.

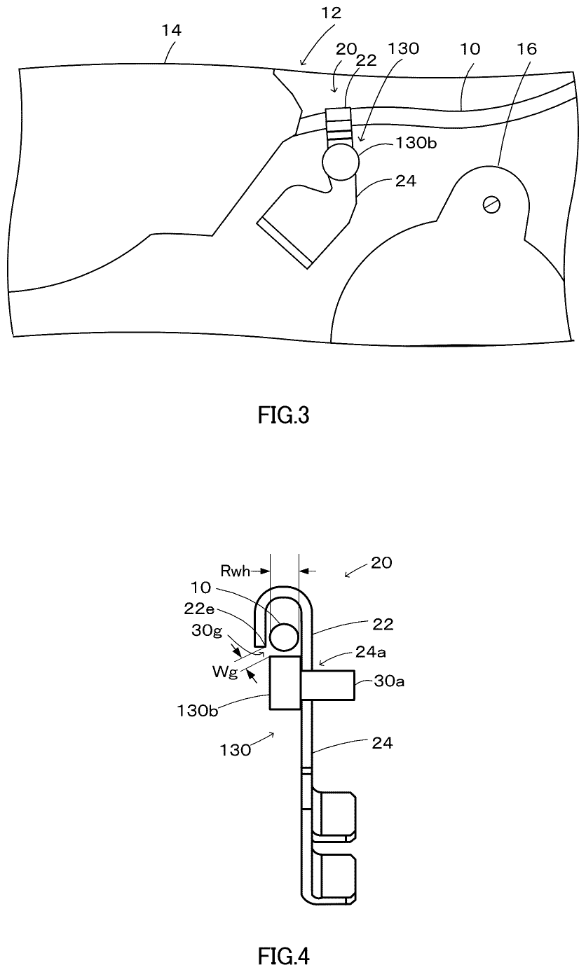

In the embodiment of the wire harness holding structure described above, the head portion 30b of the bolt 30 is shaped as a hexagonal prism. Instead of the bolt 30, a bolt 130 with a cylindrical head portion 130b may be used. FIG. 3 is a configuration diagram illustrating the schematic configuration showing a manner of attaching a clamp holding a wire harness using a wire harness holding structure according to another embodiment of the disclosure to an electric vehicle. FIG. 4 is a side configuration diagram illustrating the schematic configuration of the clamp as viewed the clamp and a bolt from a side in the wire harness holding structure of another embodiment. In another embodiment, using the bolt 130 with a cylindrical head portion 130b allows the wire harness 10 to contact curved surface of the head portion 130b. This suppresses damage to the wire harness 10 caused by the head portion 130b of the bolt 130.

In the embodiment of the wire harness holding structure described above, the shaft portion 30a of the bolt 30 has threads cut on a surface. The shaft portion 30a of the bolt 30 may include threads cut on at least a portion thereof, and may not include the threads from an end close to the head portion 30b of the shaft portion 30a to a predetermined location.

In the wire harness holding structure of the present disclosure, the head portion of the bolt may be configured to be in a cylindrical shape. The wire harness holding structure of the present disclosure damage to suppress damage to the wire harness caused by the bolt head. The wire harness caused by the head of the bolt.

The following is an explanation of the correspondence between the main elements of the embodiment and the main elements of the invention described in the section on means to solve the problem. In the embodiment, the holding portion 22 corresponds to “holding portion”, the main body portion 24 corresponds to “main body portion”, the clamp 20 corresponds to “clamp”, the shaft portion 30a corresponds to “shaft portion”, the head portion 30b corresponds to “head portion”, the bolt 30 corresponds to “bolt”, and the gap 30g corresponds to “gap”.

The correspondence between the major elements of the embodiment and the major elements of the invention described in the means to solve a problem section is an example of how the embodiment can be used to specifically explain the embodiment of the invention described in the means to solve a problem section. This does not limit the elements of the invention described in the means to solve the problem section. In other words, interpretation of the invention described in the means to solve a problem section should be based on the description in that section, and the embodiment is only one specific example of the invention described in the means to solve a problem section.

The above is a description of the form for implementing this disclosure using the embodiment. However, the present disclosure is not limited in any way to these embodiments, and can of course be implemented in various forms within the scope that does not depart from the gist of the present disclosure.

### INDUSTRIAL APPLICABILITY

This disclosure is applicable to the manufacturing industry for wire harness holding apparatuses.

What is claimed is:

1. A wire harness holding structure holding a wire harness, comprising:
a clamp including a U-shaped holding portion holding the wire harness and a main body portion extending from one end of the holding portion and including a bolt hole; and
a bolt including a shaft portion and a head portion provided at a tip of the shaft portion, wherein the shaft portion is inserted through the bolt hole from an opening side of the holding portion to fix the clamp to an object to be fixed,
wherein the bolt hole and the bolt are formed such that a gap length between the other end of the holding portion of the clamp and the head portion of the bolt is shorter than a diameter of the wire harness.

2. The wire harness holding structure according to claim 1,
wherein the head portion of the bolt is configured to be in a cylindrical shape.
